(19) United States
(12) Patent Application Publication
(10) Pub. No.: US 2026/0087934 A1
(43) Pub. Date: Mar. 26, 2026

(54) PREVENTING UNAUTHORIZED USE OF UNMANNED VEHICLES

(71) Applicant: Technology Innovation Institute - Sole Proprietorship LLC, Masdar City (AE)

(72) Inventors: Andres Lorvi, Tampere (FL); Marko Bonden, Nokia (FL)

(73) Assignee: Technology Innovation Institute - Sole Proprietorship LLC, Masdar City (AE)

(21) Appl. No.: 19/338,229

(22) Filed: Sep. 24, 2025

Related U.S. Application Data
(60) Provisional application No. 63/699,440, filed on Sep. 26, 2024.

(51) Int. Cl. G08G 9/00; G05D 1/86

(52) U.S. Cl. CPC G08G 9/00; G05D 1/86

(57) ABSTRACT

A method for integrity checking of an unmanned vehicle including obtaining a first data set from at least one sensor at a first time instant representing an operational state at the first time instant, obtaining a second data set from motion control data at the first time instant representing a control state at the first time instant, determining a signature based on the first and the second data sets, obtaining via the at least one sensor a first checking data set at a second time instant representing the operational state at the second time instant, obtaining a second checking data set from the motion control data at the second time instant representing the control state at the second time instant, determining an integrity check value by comparing the signature against the first checking data set and the second checking data set, and controlling the unmanned vehicle accordingly.

### CROSS-REFERENCE TO RELATED APPLICATION

This application claims priority to U.S. Provisional Application No. 63/699,440, filed Sep. 26, 2024, which is incorporated by reference in its entirety.

### FIELD

The disclosure relates to a method and an apparatus for preventing unauthorized use of unmanned vehicles.

### BACKGROUND

The rapid adoption of unmanned vehicles for tasks like delivery and monitoring is driving economic growth. These remote-controlled, semi-autonomous, or fully autonomous vehicles integrate with existing infrastructure, such as air traffic control. Ensuring the integrity of these operations requires reliable methods to identify and verify each unmanned aerial vehicle (UAV) throughout its operation. Stealing identities or modifying vehicles (adding, removing, or replacing parts) poses a significant security risk.

While using unmanned vehicles, it is beneficial to control and monitor their functions. These unmanned vehicles may be manually operated by an operator, semi-autonomous, or completely autonomous. In each of these cases it is beneficial to make sure that the unmanned vehicle is intact (e.g., without additional parts, equipment or payload, or that no components have been removed or changed). This applies to all kinds of unmanned vehicles, aerial, ground or surface vehicles. Especially with UAVs, authorities around the world are requiring that cooperative UAVs occupying airspace are broadcasting a remote identifier (ID) with respective information such as serial number, location, and altitude. Professional devices are generally custom built for a purpose and do not include a broadcast module by default. In addition, modules can be attached to various devices using the vehicle ID of another craft or additional non-authorized payload can be carried.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

In one aspect, the present disclosure relates to a method for integrity checking of an unmanned vehicle. The method comprises obtaining a first data set from at least one sensor of the unmanned vehicle at a first time instant, the first data set representing an operational state of the unmanned vehicle at the first time instant, obtaining a second data set from motion control data of the unmanned vehicle at the first time instant, the second data set representing a control state of the unmanned vehicle at the first time instant, determining a signature based on the first and the second data sets, obtaining via the at least one sensor of the unmanned vehicle a first checking data set at a second time instant, which is after the first time instant, the first checking data set representing the operational state of the unmanned vehicle at the second time instant, obtaining a second checking data set from the motion control data of the unmanned vehicle at the second time instant, the second checking data set representing the control state of the unmanned vehicle at the second time instant, determining an integrity check value of the unmanned vehicle by comparing the signature against the first checking data set and the second checking data set, and controlling the unmanned vehicle based on the integrity check value.

In embodiments of this aspect, the disclosure according to any one of the above example embodiments, the at least one sensor may be measuring at least one of inertia, sound, electromagnetic field, electric property of a transceiver, and power consumption.

In embodiments of this aspect, the disclosure according to any one of the above example embodiments, the at least one sensor may be measuring an activity profile of radio frequency transmission from a transceiver.

In embodiments of this aspect, the disclosure according to any one of the above example embodiments, the second data set and the second checking data set may be obtained from a control signal of a motion controller of the unmanned vehicle.

In embodiments of this aspect, the disclosure according to any one of the above example embodiments, the second data set and the second checking data set may be obtained by measuring with the at least one sensor a response of the unmanned vehicle to the control signal of the motion controller of the unmanned vehicle.

In embodiments of this aspect, the disclosure according to any one of the above example embodiments, the second data set and the second checking data set may be obtained from a subsystem of the unmanned vehicle, wherein the subsystem is one of a camera module, a communications subsystem, and a remote identification module.

In embodiments of this aspect, the disclosure according to any one of the above example embodiments, the outputting of the integrity check value may comprise transmitting the integrity check value wirelessly to an unmanned vehicle traffic controller.

In embodiments of this aspect, the disclosure according to any one of the above example embodiments, the method may comprise transmitting an indicator wirelessly to an unmanned vehicle traffic controller in response to the integrity check value not exceeding a threshold.

In one aspect, the present disclosure relates to an integrity checking apparatus comprising at least one sensor, at least one processor, and at least one memory comprising computer program code, the at least one memory and the computer program code configured to, with the at least one processor, cause the integrity checking apparatus to: receive via the at least one sensor a first data set from an unmanned vehicle at a first time instant, the first data set representing an operational state of the unmanned vehicle at the first time instant, receive a second data set from a motion controller of the unmanned vehicle at the first time instant, the second data set representing a control state of the unmanned vehicle at the first time instant, determine a signature based on the first and the second data sets, receive via the at least one sensor a first checking data set at a second time instant, which is after the first time instant, the first checking data set representing the operational state of the unmanned vehicle at the second time instant, receive a second checking data set from motion control data of the unmanned vehicle at the second time instant, the second checking data set representing the control state of the unmanned vehicle at the second time instant, determine an integrity check value of the unmanned vehicle by comparing the signature against the first and the second checking data sets, and control the unmanned vehicle based on the integrity check value.

In embodiments of this aspect, the disclosure according to any one of the above example embodiments, the at least one sensor may be measuring one of inertia, sound, electromagnetic field, and an electric property of a transceiver.

In embodiments of this aspect, the disclosure according to any one of the above example embodiments, the at least one sensor may be measuring an activity profile of radio frequency transmission from a transceiver.

In embodiments of this aspect, the disclosure according to any one of the above example embodiments, the integrity checking apparatus may comprise a second sensor, wherein the at least one memory comprising the computer program code is further configured to, with the at least one processor, cause the integrity checking apparatus to obtain the second data set and the second data from the second sensor by measuring a control signal of the motion controller of the unmanned vehicle.

In embodiments of this aspect, the disclosure according to any one of the above example embodiments, the second sensor may be a motion sensor configured to measure a response of the unmanned vehicle to an action of the motion controller of the unmanned vehicle.

In embodiments of this aspect, the disclosure according to any one of the above example embodiments, the integrity checking apparatus may be configured to obtain the second data set and the second checking data set from a subsystem of the unmanned vehicle, wherein the subsystem is one of a camera module, a communications subsystem, and a remote identification module.

In embodiments of this aspect, the disclosure according to any one of the above example embodiments, the integrity checking apparatus may be further caused to transmit the integrity check value wirelessly to an unmanned vehicle traffic controller.

In embodiments of this aspect, the disclosure according to any one of the above example embodiments, in response to the integrity check value not exceeding a threshold, the integrity checking apparatus may be caused to transmit an indicator wirelessly to an unmanned vehicle traffic controller.

In one aspect, the present disclosure relates to a non-transitory, computer-readable medium storing instructions that, when executed by at least one processor of an unmanned vehicle, perform a method for integrity checking, comprising: obtaining via at least one sensor a first data set from the unmanned vehicle, the first data set representing an operational state of the unmanned vehicle at a first time instant, obtaining a second data set from motion control data of the unmanned vehicle, the second data set representing a control state of the unmanned vehicle at the first time instant, determining a signature based on the first and the second data sets, obtaining via the at least one sensor of the unmanned vehicle a first checking data set, the first checking data set representing the operational state of the unmanned vehicle at the second time instant, obtaining a second checking data set from the motion control data of the unmanned vehicle, wherein the first checking data set is different from the second checking data set, the second checking data set representing the control state of the unmanned vehicle at the second time instant, determining an integrity check value of the unmanned vehicle by comparing the signature against the sensors a first and a second checking data set, and controlling the unmanned vehicle based on the integrity check value.

In embodiments of this aspect, the disclosure according to any one of the above example embodiments, the first data set and the first checking data set may be one of inertia, sound, electromagnetic field, and electric property of a transceiver.

In embodiments of this aspect, the disclosure according to any one of the above example embodiments, the at least one sensor may be measuring an activity profile of radio frequency transmission from a transceiver.

In embodiments of this aspect, the disclosure according to any one of the above example embodiments, the second data set and the second checking data set may be obtained by measuring a parameter of a motion controller of the unmanned vehicle.

In embodiments of this aspect, the disclosure according to any one of the above example embodiments, the second data set and the second checking data set may be obtained by measuring the response of the unmanned vehicle to an action of the motion controller of the unmanned vehicle.

In embodiments of this aspect, the disclosure according to any one of the above example embodiments, the second data set and the second checking data set may be obtained from a subsystem of the unmanned vehicle, wherein the subsystem is one of a camera module, a communications subsystem, and a remote identification module.

In embodiments of this aspect, the disclosure according to any one of the above example embodiments, the method may comprise transmitting the integrity check value wirelessly to an unmanned vehicle traffic controller.

In embodiments of this aspect, the disclosure according to any one of the above example embodiments, the method may comprise, in response to the integrity check value not exceeding a threshold, determining an indicator and transmitting the indicator wirelessly to an unmanned vehicle traffic controller.

The foregoing general description of the illustrative embodiments and the following detailed description thereof are merely exemplary aspects of the teachings of this disclosure and are not restrictive.

### BRIEF DESCRIPTION OF THE DRAWINGS

So that the above-recited features of the present disclosure can be understood in detail, a more particular description of the disclosure, briefly summarized above, may be made by reference to example embodiments, some of which are illustrated in the appended drawings. It is to be noted, however, that the appended drawings illustrate only example embodiments of this disclosure and are therefore not to be considered limiting of its scope, for the disclosure may admit to other equally effective example embodiments.

FIG. 1 illustrates unmanned vehicles and an unmanned vehicle traffic controller, according to aspects of the present disclosure.

FIG. 2 illustrates a method for integrity checking of an unmanned vehicle, according to aspects of the present disclosure.

FIG. 3 illustrates another method, for integrity checking of an unmanned vehicle according to aspects of the present disclosure.

FIG. 4 illustrates an arrangement of the integrity checking apparatus, according to aspects of the present disclosure.

FIG. 5 illustrates another arrangement of the integrity checking apparatus, according to aspects of the present disclosure.

### DETAILED DESCRIPTION

To mitigate the above-presented problem, an integrity checking method may be used and an integrity checking apparatus may be attached to an unmanned vehicle. The solution can be used for any subsystem in the unmanned vehicle. In a UAV, a critical subsystem is the flight computer.

It is noted that integrity may be a challenge for UAVs operating in shared airspace. Regulatory bodies are mandating remote identification systems that broadcast data like serial numbers, location, and even mission plans. However, the custom-built nature of many professional UAVs composed of multiple subsystems, makes them susceptible to modifications that could exploit these vulnerabilities. The capability presented in this disclosure form provides methods to mitigate such a problem.

The method may be based in part on detecting physical changes in the unmanned vehicle, especially changes in response to motion control signals of an unmanned vehicle. These changes may be changes (e.g. possibly malicious/unauthorized) made to the unmanned vehicle authorized to use the electronic device hosting the remote ID, or the changes may be due to the electronic device hosting the remote ID being removed from the authorized unmanned vehicle and mounted to another (e.g. possibly malicious/unauthorized) unmanned vehicle. A pairing may be performed by forming a digital signature from obtained sensor data from the unmanned vehicle. A paired subsystem in the unmanned vehicle may only work with the host unmanned vehicle configuration which was present during pairing. The subsystem can be preprogrammed to work only with certain category of devices with certain physical properties. Changes in the configuration of the unmanned vehicle may be detected if the host unmanned vehicle or unmanned vehicle type is changed, or if mass is added or removed. Changes in device configuration may also be detected via changes in the radio frequency spectrum of the device. Subsystems of the unmanned vehicle can be, for example, a mission controller/computer and an unmanned vehicle remote identification device.

Secure physical pairing capability can potentially be utilized with no additional cost to the system. The subsystem's capability may be extended by adding inertial measurement units and radio frequency (RF) measurement capability. The inertial measurement may be used to extract a fingerprint of the mechanical motion/vibration of the unmanned vehicle. This fingerprint may be used to pair a subsystem rendering the unmanned vehicle unusable if the host vehicle fingerprint changes. Changes to the mechanical resonance fingerprint can be induced by replacing the underlying unmanned vehicle, parts of the unmanned vehicle or introduced and or removed parts.

In addition to inertial measurement-based fingerprinting, RF properties can be also used to introduce more ways to construct a fingerprint. An RF fingerprint can be constructed from the measured RF spectrum of the transmitters in the unmanned vehicle. Additionally, the static magnetic field of the host system can be measured, and any change detected. The RF spectrum can utilize the electromagnetic interference of the device as a part of the fingerprint construction. The subsystem device can have direct connectivity and access to listen for the internal communication of the unmanned vehicle. Based on the internal communication protocols a fingerprint can be constructed based on the typical behavior of the unmanned vehicle.

Determining the fingerprint can be configured with different time spans and durations depending on the measurement technology, the type of operation the unmanned vehicle may be instructed to carry out, and external factors affecting the measurements such as expected interruption and effect of weather. For example, an inertial measurement of acceleration in matters of milliseconds to seconds can already detect vehicle characteristics such as response to propulsion increase or balance in angular velocity. On the other hand, a change in speed or duration of a mission measurement during several minutes can be detected. RF transmission activity during a mission may also be measured and changes in the activity may be detected. For example, an unexpectedly increased video streaming during a mission may be detected by monitoring the RF activity. The usage of video streaming during a mission may be pre-programmed for saving power, for example, and a changed profile of video streaming activity during a mission may be detected.

In the event where the fingerprint may be altered, the subsystems can react in multiple ways. In the case of the remote ID broadcasting device, the unmanned vehicle can communicate the situation by sending a distress signal to the authority and then introduce information about the potentially compromised unmanned vehicle identity. In the case of a mission computer, the subsystem can react, for example, by aborting the mission, returning to base, limiting its performance, or notifying the user or another party.

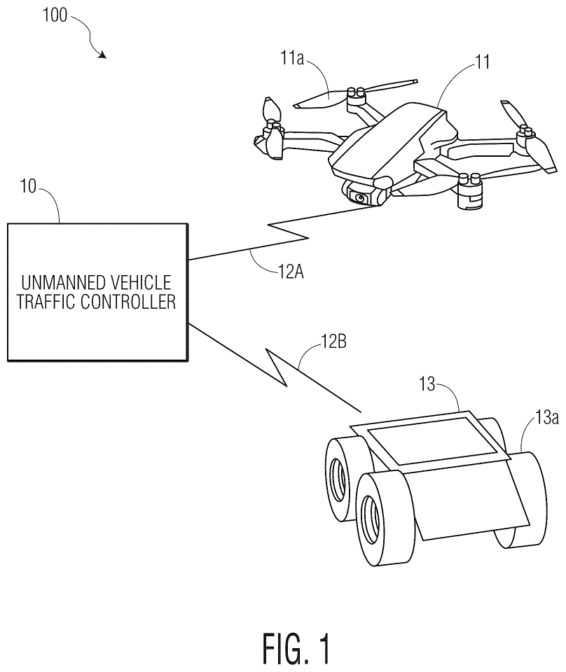

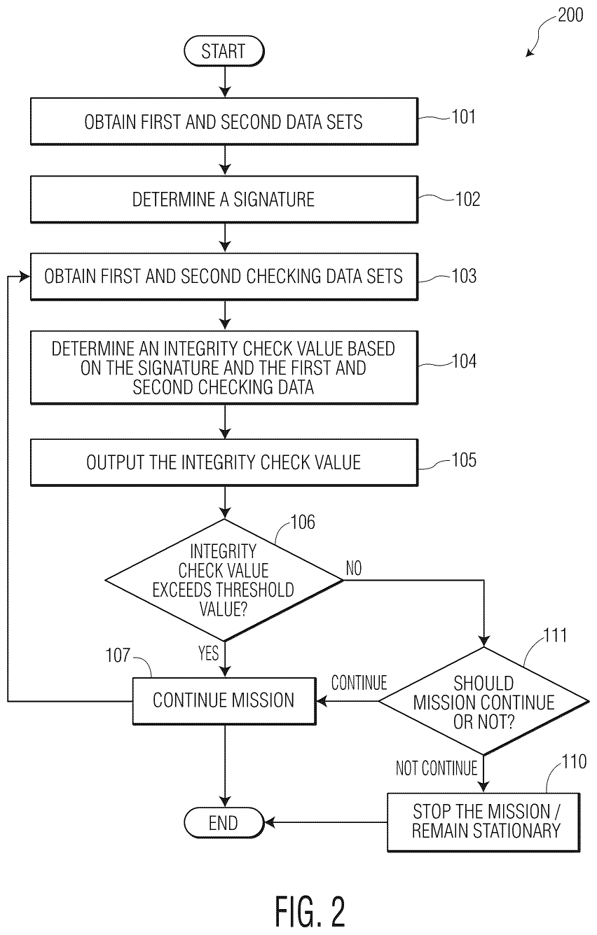

Referring to FIGS. 1-3, according to an example of the disclosure, there are methods 200 and 300 for integrity checking of an unmanned vehicle 11 or 13 shown in system diagram 100. For example, in reference to FIG. 2, at a first time instant a first data set may be obtained in step 101 via at least one sensor (not shown) from the unmanned vehicle 11 or 13 via communication links 12A or 12B, a second data set may be obtained in step 101 from motion control data of the unmanned vehicle 11 or 13, and a signature may be determined in step 102 based on the first and the second data sets. The obtaining of the first and second data sets may be performed during a time period. The time period may range, for example, from 1 second to several minutes, but it is not limited to these time periods. The length of the time period may be set so that a movement of the unmanned vehicle 11 or 13 may be recorded. The length of the period may also be longer, like the duration of a mission. At a second time instant after the first time instant, a first checking data set may be obtained in step 103 via the at least one sensor from the unmanned vehicle 11 or 13, and a second checking data set may be obtained in step 103 from the motion control data of the unmanned vehicle 11 or 13. The duration of obtaining the first and second checking data sets may be generally the same length as the time period for obtaining the first and second data sets. Events may be recorded during the recording of the first data set and the first checking data set, and respectively during the second data set and the second checking data set. An integrity check value of the unmanned vehicle 11 or 13 may be determined in step 104 by comparing the signature against the first checking data set and the second checking data set, and the integrity check value may be output in step 105. The integrity check value may be a correlation between the signature and the checking data sets, where a high correlation may indicate that the unmanned vehicle is behaving as expected (e.g. appears to be the same unmanned vehicle), and a lower correlation may indicate that the unmanned vehicle is behaving unexpectedly (e.g. appears to be a different unmanned vehicle or the unmanned vehicle has been modified in some way).

After step 105, in response to the integrity check value not exceeding a pre-stored integrity check value in step 106 (e.g. the correlation between the data sets being below a threshold), the unmanned vehicle may be configured to cancel its mission and to perform one of remaining stationary or returning to a pre-assigned location. The pre-assigned location may be the starting point of the mission. The threshold value may be transmitted wirelessly by the unmanned vehicle 11 or 13 controller to the unmanned vehicle 11 or 13. In another example the threshold value may be pre-stored in a memory 40 of the unmanned vehicle 11 or 13.

When the integrity check value does not exceed the threshold value, the method may include step 111 where the unmanned vehicle controller determines whether or not the mission should continue. This determination may be made locally by the unmanned vehicle and may include an analysis of unmanned vehicle data, mission parameters and other relevant information. In some cases, the unmanned vehicle may determine that the mission can continue (step 107) as planned, or with some modifications, when the analysis reveals that the unmanned vehicle has been modified by an authorized or trusted entity. In other cases, the unmanned vehicle may determine that the mission should be stopped or aborted (step 110) when the analysis indicates a possibility that the unmanned vehicle has been modified by an unauthorized or potentially malicious actor. The specific criteria and decision-making process for continuing or stopping the mission may be configurable based on the particular use case and security requirements.

When the integrity check value exceeds the threshold value (e.g. the correlation between the data sets being above the threshold), the mission of the unmanned vehicle may be continued (step 107). In other words, the unmanned vehicle may determine that the mission can proceed since no unauthorized changes or modifications to the unmanned vehicle are suspected based on the integrity check. This determination to continue the mission may be made locally by the unmanned vehicle's onboard systems. The threshold value used for comparison may be pre-configured or dynamically adjusted based on operational conditions. In some implementations, even if the integrity check passes, additional verification steps or restricted operational modes may be applied as an extra precaution before fully resuming normal mission operations.

It is noted that the first data set and the first checking data set may be operational states of the vehicle which are from the results of measuring a signal of the at least one sensor at two different time instants. Accordingly, the second data set and the second checking data set may be control states of the vehicle which are obtained from the results of motion control data at two different time instants. The determined signature at the first time instant may be generated as a default signature when the unmanned vehicle 11 or 13 may be checked to be intact or includes only the intended structures, components, and payloads. The signature may be used as a reference in later integrity checking.

The first data set measured by the at least one sensor may be e.g. an inertial measurement of the unmanned vehicle 11 or 13, an orientation measurement of the unmanned vehicle 11 or 13, a sound or a vibration. The inertial measurement may be measuring linear acceleration of the unmanned vehicle 11 or 13 or angular velocity of the unmanned vehicle 11 or 13 in rotation with respect to an imaginary axis. The first data set measured by the at least one sensor may also be an electromagnetic sensor measuring electromagnetic radiation or measuring an electric property (e.g. power consumption) of a transceiver of the unmanned vehicle 11 or 13. The signature may be a digital signature created by performing an algorithm that identifies features of the first data set and produces a shorter data set that may be associated with the first and second data sets. Examples of such algorithms are feature extraction algorithms or statistical modelling functions. The method may be configured to obtain a third data set from a second sensor to perform sensor fusion between the first and third data sets, and further to determine the signature based on the fused data set and the second data set. Sensor fusion may be used generally to combine sensor data derived from the at least one sensor and the second sensor such that the resulting combined information from the sensors has less uncertainty than would be possible when these sources were used individually. Sensor fusion may be performed by a number of methods and algorithms, such as a Kalman filter, Bayesian networks, Convolutional neural network or Gaussian processes to name a few. Sensor fusion may be used to improve the act of determining the signature, as the combined data can represent an event more accurately than data from a single sensor. The signature creation may shorten the data set to be stored for later comparison with the second data set and the second checking data sets. The feature extraction algorithms and statistical modelling functions may capture features of the data of the first data set. The difference between feature extraction algorithms and statistical modelling may be that the feature extraction algorithms may be selected so that they preserve characteristics of the data being modelled, whereas statistical modelling functions typically capture collective characteristics of the first data set. When the at least one sensor may be measuring a physical magnitude, it may be beneficial to capture information of the physical response in acceleration, orientation, motion, or vibration. The information of the physical response with respect to motion control may provide information of the physical changes in the unmanned vehicle 11 or 13.

The motion control data may be data produced by a controller circuitry of the unmanned vehicle 11 or 13. The motion control data may represent signals controlling motors, propulsion, or steering elements, such as ailerons or blades 11a of an unmanned aerial vehicle 11, or wheels 13a or chain tread of an unmanned ground vehicle 13.

The method may determine a correlation or a dependency relation between the motion control data of the unmanned vehicle 11 or 13 and one physical response, like acceleration, orientation, inertia, or vibration, or, on the other hand, between the motion control data of the unmanned vehicle 11 or 13 and one of electric response of the unmanned vehicle 11 or 13. The method recognizes changes in the physical response or electric response of the unmanned vehicle 11 or 13 with respect to motion control. A change in the physical response may be a result of added or reduced weight, changed balance, or shifted center of mass of the unmanned vehicle 11 or 13. The method may pair the first data set and the second data set. In the pairing, the signature may be created to shorten the pair of the first and the second data sets. A similar signature may be also created for the measurement data of the second time instant. The use of signatures allows the collection of longer samples for the first data set and the second data set. The integrity check value may be determined based on the correlation or dependency between the first data set and the motion control data. The correlation strength may depend on the type of changes. For example, a small weight change may produce a small change in physical response in the acceleration of the unmanned vehicle 11 or 13, while a small change in weight and a large change in the center of mass may produce a strong correlation when measuring angular velocity. Different kinds of changes may be weighed differently in determining the output integrity check value. Therefore, the output integrity check value may have a range of results describing the significance of the change based on the strength in correlation between the data.

The integrity check value may be used to assess if any changes have been made to the unmanned vehicle 11 or 13. It is also possible that the motion response of the unmanned vehicle 11 or 13 may be affected by external factors such as weather, especially for unmanned aerial vehicles 11, or by terrain conditions for unmanned ground vehicles 13. These external factors may also be used in determining the integrity check value.

According to an example, an activity of the RF transceiver may be measured by the at least one sensor, and a RF activity profile of transmissions from the transceiver during the time period may be determined. The RF activity profile may be used as the first data set in determining the fingerprint. For example, the RF activity profile may include data on RF power across bands of the transceiver during the time period, and the RF activity profile may be used to determine the fingerprint. The bands of the transceiver may refer to the electromagnetic spectrum in which the transceiver may be configured to transmit or receive. Measuring RF power may be performed by known techniques. Determining the fingerprint based on the obtained RF activity profile may take a longer time period. In any case, the second data set may still be obtained from the motion control data as the mission movement can be obtained from this data. The method pairs the RF activity profile with the motion control data to determine the fingerprint. The method may extract features from the first data set at selected time intervals during the time period. The time intervals may be selected based on features of the motion control data. For example, when the unmanned vehicle is providing motion controls to change the motion of the unmanned vehicle, like turning, accelerating, or performing a series of such changes in motion, the at least one sensor may be configured to obtain data to the first data set, as such time intervals are likely of more interest than an interval of a steady motion.

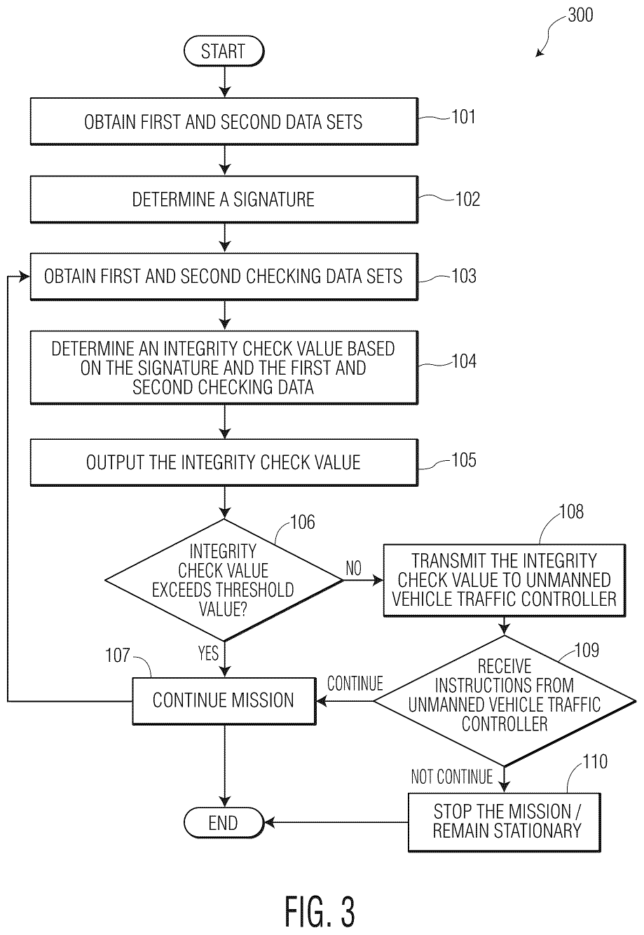

According to an example of the method in FIG. 3, a remote party such as a vehicle traffic controller may be involved in analysis and decision making based on the integrity check value. For example, after step 106, when the integrity check value does not exceed the threshold value, the method may include transmitting the integrity check value wirelessly to an unmanned vehicle traffic controller 10 in step 108. The unmanned vehicle traffic controller 10 may store a pre-stored threshold integrity check value for the unmanned vehicle 11 or 13. In response to the received integrity check value from the unmanned vehicle 11 or 13 exceeding the pre-stored threshold integrity check value, the mission of the unmanned vehicle may be continued in step 107 with or without modifications by the traffic controller 10. In response to the received integrity check value from the unmanned vehicle 11 or 13 not exceeding the pre-stored integrity check value, the unmanned traffic controller 10 may perform at least one of transmitting an instruction to the unmanned vehicle 11 or 13 in step 109, and if the instruction is to not continue the mission, in step 110 an instruction to stop a mission of the unmanned vehicle 11 or 13 or an instruction to remain stationary may be transmitted to the unmanned vehicle 11 or 13.

In some implementations, the unmanned vehicle traffic controller 10 may perform additional analysis on the received integrity check value and other relevant data before making a decision. This analysis may take into account factors such as the specific type of unmanned vehicle, the nature of its current mission, environmental conditions, and any other pertinent information available to the traffic controller. Based on this comprehensive analysis, the traffic controller may determine an appropriate course of action, which could include allowing the mission to continue as planned, modifying mission parameters, instructing the vehicle to return to base, or initiating emergency protocols. The traffic controller 10 may also maintain a historical record of integrity check values for each unmanned vehicle under its supervision. This data may be used to identify trends or patterns that could indicate gradual changes in a vehicle's condition over time, even if individual integrity checks remain within acceptable thresholds. Such long-term analysis may help in predictive maintenance and early detection of potential issues. In some cases, the traffic controller 10 may coordinate with other systems or authorities when making decisions based on integrity check values. For example, it may consult with air traffic control systems, weather monitoring stations, or security agencies to gather additional context that may influence the decision-making process. The method may also include provisions for the unmanned vehicle 11 or 13 to request clarification or provide additional information to the traffic controller 10 if needed. This two-way communication may help ensure that decisions are made based on the most complete and up-to-date information available. According to an example method the signature may be determined based on data from a subsystem of the unmanned vehicle 11 or 13. In an example, the first data set and the first checking data set may be obtained from the subsystem. The data may include, for example, a camera module output, a response from a communications subsystem, or a response of a remote ID broadcasting module. In determining the signature, the first data set, and the first checking data set, represent an output of the subsystem during the signature-determining event.

The data may include, for example, a camera module output, a response from a communications subsystem, or a response of a remote ID broadcasting module. In determining the signature, the first data set, and the first checking data set, represent an output of the subsystem during the signature-determining event.

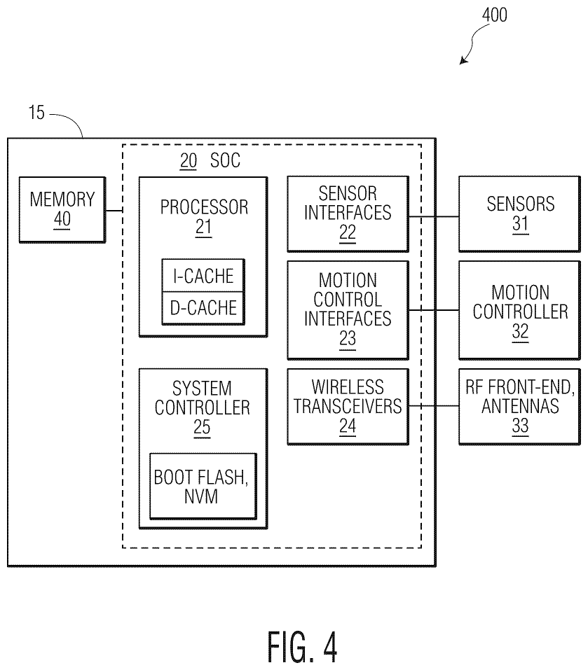

Referring to FIG. 4, according to an example of the disclosure, there is a system 400 including an integrity checking apparatus 15 including at least one processor 21 including cache memory (e.g. I-cache, D-cache, etc.), and at least one memory device 40 including computer program code, which may be configured to, with the at least one processor 21, cause the integrity checking apparatus 15, at a first time instant, to receive via the at least one sensor 31 a first data set from an unmanned vehicle 11 or 13 and to receive a second data set from a motion controller 32 of the unmanned vehicle 11 or 13. The at least one memory 40 and the computer program code are further configured to, with the at least one processor, cause the integrity checking apparatus 15, to determine a digital signature based on the first and second data sets obtained at the first time instant. The determined signature at the first time instant may be generated as the default signature when the unmanned vehicle 11 or 13 may be checked to be intact or include only the intended structures, components, and payloads. The signature may be used as a reference in later integrity checking. The integrity checking apparatus 15 further includes system controller 25 including memory (e.g. boot flash, etc.), wireless communication transceivers 24 for connection to antennas 33, and interfaces 22, 23 for the at least one sensor 31 and the motion controller 32, respectively. In FIG. 4, the processor 21, interfaces 22, 23, wireless transceiver 24 and system controller 25 may be implemented as a system on a chip circuit (SoC) 20, but they may be implemented with separate components or circuits as well. For security aspects and trust building it may be useful to implement the program code for determining the signature in a trusted computing environment.

The at least one memory 40 and the computer program code are further configured to, with the at least one processor, cause the integrity checking apparatus, at a second time instant, to receive via the at least one sensor 31 a first checking data set from an unmanned vehicle 11 or 13 and to receive a second checking data set from the motion controller 32 of the unmanned vehicle 11 or 13. Furthermore, the at least one memory and the computer program code may be configured to, with the at least one processor, cause the integrity checking apparatus, at a second time instant, to determine an integrity check value of the unmanned vehicle 11 or 13 by comparing the signature against the first and the second checking data set, and output the integrity check value.

The at least one sensor 31 may be configured to measure values such as an inertial measurement of the unmanned vehicle 11 or 13, an orientation of the unmanned vehicle 11 or 13, a sound or a vibration. The sound and the vibration may be recorded by a microphone or a vibration sensor. The at least one sensor 31 may be configured to measure inertia (e.g. by measuring linear acceleration or angular velocity in rotation of the unmanned vehicle 11 or 13 with respect to an imaginary axis). In an example, the at least one sensor 31 may be an electromagnetic sensor configured to measure electromagnetic radiation or an electric property of a transceiver of the unmanned vehicle 11 or 13. The signature may be a digital signature created by performing an algorithm that identifies features of the first data set and produces significantly shorter data that may be associated with the first and second data sets. Examples of such algorithms are feature extraction algorithms or statistical modelling functions.

The integrity checking apparatus 15 may be further configured to receive motion control data from a controller 32 circuitry of the unmanned vehicle 11 or 13. The motion control data may represent signals controlling motors, propulsion, or steering elements, such as ailerons or blades 11a of an unmanned aerial vehicle 11, or wheels 13a or chain tread of an unmanned ground vehicle 13. The at least one memory and the computer program code may be further configured to, with the at least one processor, cause the integrity checking apparatus 15 to determine a correlation or a dependency relation between the motion control data of the unmanned vehicle 11 and one physical response, like acceleration, orientation, inertia, or vibration, or on the other hand between the motion control data of the unmanned vehicle 11 or 13 and one of electric response of the unmanned vehicle 11 or 13. According to another example, the integrity checking apparatus 15 may be configured, in response to the integrity check value not exceeding a pre-stored threshold integrity check value, to cause the unmanned vehicle to cancel its mission and to perform one of remaining stationary or returning to a preassigned location. The preassigned location may be the starting point of the mission. The threshold may be received wirelessly via the wireless transceiver 24. In an example, the threshold may be pre-stored in memory 40 of the integrity checking apparatus 15. In response to the integrity check value exceeding the threshold, the mission of the unmanned vehicle may be continued.

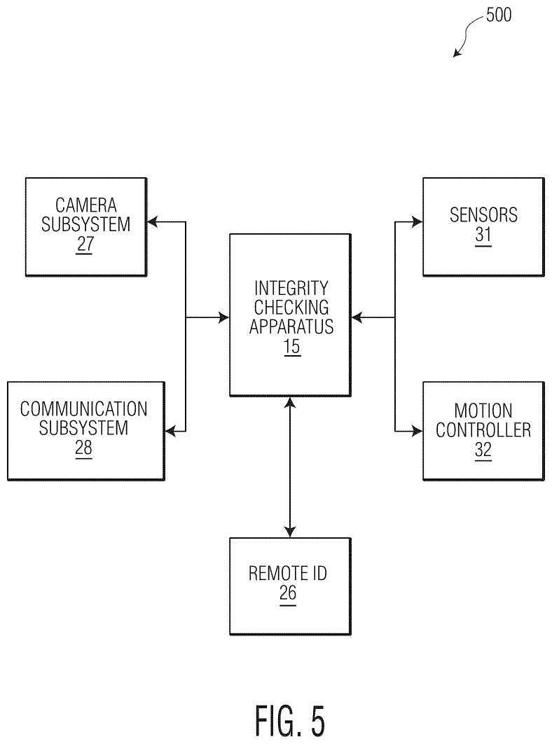

Referring to FIG. 5, according to an example, the integrity checking apparatus 15 may be configured to determine a signature for a subsystem of the unmanned vehicle 11 or 13. The subsystem may be, for example, a camera module 27, a communications subsystem 28 or a remote ID broadcasting module 26. In the example, the first data set and the first checking data set may be obtained from the subsystem. In determining the signature, the first data set, and the first checking data set, may represent an output of the subsystem during the signature determining event.

According to another example, there may be a non-transitory, computer readable medium storing instructions that, when executed by at least one processor of an unmanned vehicle 11 or 13, perform a method for integrity checking. The steps may include obtaining via at least one sensor from the unmanned vehicle 11 or 13 a first data set, obtaining a second data set from motion control data of the unmanned vehicle 11 or 13, where the first data set may be different from the second data set, determining a signature based on the first and the second data sets, obtaining via the at least one sensor from the unmanned vehicle 11 or 13 a first checking data set, obtaining a second checking data set from motion control data of the unmanned vehicle 11 or 13, where the first checking data set may be different from the second checking data set, determining an integrity check value of the unmanned vehicle 11 or 13 by comparing the signature against the sensors a first and a second checking data set, and outputting the integrity check value. The first data set and the first checking data set may be results of measuring the at least one sensor at two different time instants. Accordingly, the second data set and the second checking data set may be results of motion control data at two different time instants. The determined signature at the first time instant may be generated as the default signature when the unmanned vehicle 11 or 13 may be checked to be intact or include only the intended structures, components, and payloads. The signature may be used as a reference in later integrity checking.

The non-transitory, computer-readable medium may include instructions to obtain the first data set to be measured by the at least one sensor (e.g. an inertial measurement or an orientation of the unmanned vehicle 11 or 13, a sound, or a vibration). The inertial measurement may measure the linear acceleration of the unmanned vehicle 11 or 13 or the angular velocity of the unmanned vehicle 11 or 13 in rotation with respect to an imaginary axis. The first data set measured by the at least one sensor may also be an electromagnetic sensor measuring electromagnetic radiation or measuring an electric property of a transceiver of the unmanned vehicle 11 or 13. The non-transitory, computer-readable medium may include instructions to create a digital signature by performing an algorithm that identifies features of the first data set and produces significantly shorter data that may be associated with the first and second data sets. Examples of such algorithms may include feature extraction algorithms or statistical modelling functions. The purpose of the signature creation may be to shorten the data to be stored for later comparison with the second data set and the second checking data sets. The feature extraction algorithms and statistical modelling functions may capture features of the data of the first data set. The difference between feature extraction algorithms and statistical modelling may be that the feature extraction algorithms may be selected so that they preserve characteristics of the data being modelled, whereas statistical modelling functions typically capture collective characteristics of the first data set. When the at least one sensor may be measuring a physical magnitude, it may be beneficial to capture information of the physical response in acceleration, orientation, inertia, or vibration. The information of the physical response with respect to motion control may provide information of the physical changes in the unmanned vehicle 11 or 13.

The non-transitory, computer-readable medium may include instructions to perform the above-mentioned methods for determining a correlation or a dependency relation between the motion control data of the unmanned vehicle 11 or 13 and one physical response, like acceleration, orientation, inertia, or vibration, or on the other hand between the motion control data of the unmanned vehicle 11 or 13 and one of electric response of the unmanned vehicle 11. The motion control data may represent signals controlling motors, propulsion, or steering elements, such as ailerons or blades 11a of an unmanned aerial vehicle 11, or wheels 13a or chain tread of an unmanned ground vehicle 13.

The non-transitory, computer-readable medium may include instructions to perform the above-mentioned methods for outputting the integrity check value and transmitting the integrity check value wirelessly (e.g. to an unmanned vehicle traffic controller 10, or in response to the integrity check value not exceeding a pre-stored integrity check value to cause the unmanned vehicle to cancel its mission, and to perform one of remaining stationary or returning to a pre-assigned location).

The non-transitory, computer-readable medium may include instructions to perform the above-mentioned methods for transmitting the integrity check value wirelessly to an unmanned vehicle traffic controller 10 and in response to the received integrity check value from the unmanned vehicle 11 or 13 not exceeding the pre-stored integrity check value, to stop a mission of the un-manned vehicle 11 or 13 and to remain stationary.

The non-transitory, computer-readable medium may include instructions to determine the signature based on data from a subsystem of the unmanned vehicle 11 or 13. In the method, the first data set and the first checking data set are obtained from the subsystem. The data may include, for example, a camera module output, a response from a communications subsystem or a response of a remote ID broadcasting module. In determining the signature, the first data set, and the first checking data set, represent an output of the subsystem during the signature determining event.

While the foregoing is directed to example embodiments described herein, other and further example embodiments may be devised without departing from the basic scope thereof. For example, aspects of the present disclosure may be implemented in hardware or software or a combination of hardware and software. One example embodiment described herein may be implemented as a program product for use with a computer system. The program(s) of the program product defines functions of the example embodiments (including the methods described herein) and may be contained on a variety of computer-readable storage media. Illustrative computer-readable storage media include, but are not limited to: (i) non-writable storage media (e.g., read-only memory (ROM) devices within a computer, such as CD-ROM disks readably by a CD-ROM drive, flash memory, ROM chips, or any type of solid-state non-volatile memory) on which information is permanently stored; and (ii) writable storage media (e.g., floppy disks within a diskette drive or hard-disk drive or any type of solid-state random-access memory) on which alterable information is stored. Such computer-readable storage media, when carrying computer-readable instructions that direct the functions of the presented example embodiments, are example embodiments of the present disclosure.

It will be appreciated by those skilled in the art that the preceding examples are exemplary and not limiting. It is intended that all permutations, enhancements, equivalents, and improvements thereto are apparent to those skilled in the art upon a reading of the specification and a study of the drawings are included within the true spirit and scope of the present disclosure. It is therefore intended that the following appended claims include all such modifications, permutations, and equivalents as fall within the true spirit and scope of these teachings.

What is claimed is:

1. A method for integrity checking of an unmanned vehicle, the method comprising:
obtaining a first data set from at least one sensor of the unmanned vehicle at a first time instant, the first data set representing an operational state of the unmanned vehicle at the first time instant;
obtaining a second data set from motion control data of the unmanned vehicle at the first time instant, the second data set representing a control state of the unmanned vehicle at the first time instant;
determining a signature based on the first and the second data sets;
obtaining via the at least one sensor of the unmanned vehicle a first checking data set at a second time instant, which is after the first time instant, the first checking data set representing the operational state of the unmanned vehicle at the second time instant;
obtaining a second checking data set from the motion control data of the unmanned vehicle at the second time instant, the second checking data set representing the control state of the unmanned vehicle at the second time instant;
determining an integrity check value of the unmanned vehicle by comparing the signature against the first checking data set and the second checking data set; and
controlling the unmanned vehicle based on the integrity check value.

2. The method according to claim 1, wherein the at least one sensor is measuring at least one of inertia, sound, electromagnetic field, electric property of a transceiver, and power consumption.

3. The method according to claim 1, wherein the at least one sensor is measuring an activity profile of radio frequency transmission from a transceiver.

4. The method according to claim 1, wherein the second data set and the second checking data set are obtained from a control signal of a motion controller of the unmanned vehicle.

5. The method according to claim 4, wherein the second data set and the second checking data set are obtained by measuring with the at least one sensor a response of the unmanned vehicle to the control signal of the motion controller of the unmanned vehicle.

6. The method according to claim 1, wherein the second data set and the second checking data set are obtained from a subsystem of the unmanned vehicle, wherein the subsystem is one of a camera module, a communications subsystem, and a remote identification module.

7. The method according to claim 1, wherein the outputting of the integrity check value comprises transmitting the integrity check value wirelessly to an unmanned vehicle traffic controller.

8. An integrity checking apparatus comprising:
at least one sensor;
at least one processor; and
at least one memory comprising computer program code, the at least one memory and the computer program code configured to, with the at least one processor, cause the integrity checking apparatus to:
receive via the at least one sensor a first data set from an unmanned vehicle at a first time instant, the first data set representing an operational state of the unmanned vehicle at the first time instant;
receive a second data set from a motion controller of the unmanned vehicle at the first time instant, the second data set representing a control state of the unmanned vehicle at the first time instant;
determine a signature based on the first and the second data sets;
receive via the at least one sensor a first checking data set at a second time instant, which is after the first time instant, the first checking data set representing the operational state of the unmanned vehicle at the second time instant;
receive a second checking data set from motion control data of the unmanned vehicle at the second time instant, the second checking data set representing the control state of the unmanned vehicle at the second time instant;
determine an integrity check value of the unmanned vehicle by comparing the signature against the first and the second checking data sets; and
control the unmanned vehicle based on the integrity check value.

9. The integrity checking apparatus according to claim 8, wherein the at least one sensor is measuring one of inertia, sound, electromagnetic field, and an electric property of a transceiver.

10. The integrity checking apparatus according to claim 8, wherein the at least one sensor is measuring an activity profile of radio frequency transmission from a transceiver.

11. The integrity checking apparatus according to claim 8, comprising: a second sensor, wherein the at least one memory comprising the computer program code is further configured to, with the at least one processor, cause the integrity checking apparatus to obtain the second data set and the second data from the second sensor by measuring a control signal of the motion controller of the unmanned vehicle.

12. The integrity checking apparatus according to claim 11, wherein the second sensor is a motion sensor configured to measure a response of the unmanned vehicle to an action of the motion controller of the unmanned vehicle.

13. The integrity checking apparatus according to claim 8, wherein the integrity checking apparatus is configured to obtain the second data set and the second checking data set from a subsystem of the unmanned vehicle, wherein the subsystem is one of a camera module, a communications subsystem, and a remote identification module.

14. The integrity checking apparatus according to claim 8, wherein in response to the integrity check value not exceeding a threshold, the integrity checking apparatus is caused to transmit an indicator is transmitted wirelessly to an unmanned vehicle traffic controller.

15. A non-transitory, computer-readable medium storing instructions that, when executed by at least one processor of an unmanned vehicle, perform a method for integrity checking, comprising:
obtaining via at least one sensor a first data set from the unmanned vehicle, the first data set representing an operational state of the unmanned vehicle at a first time instant;
obtaining a second data set from motion control data of the unmanned vehicle, the second data set representing a control state of the unmanned vehicle at the first time instant;
determining a signature based on the first and the second data sets;
obtaining via the at least one sensor of the unmanned vehicle a first checking data set, the first checking data set representing the operational state of the unmanned vehicle at the second time instant;
obtaining a second checking data set from the motion control data of the unmanned vehicle, wherein the first checking data set is different from the second checking data set, the second checking data set representing the control state of the unmanned vehicle at the second time instant;
determining an integrity check value of the unmanned vehicle by comparing the signature against the sensors a first and a second checking data set; and
controlling the unmanned vehicle based on the integrity check value.

16. The non-transitory, computer-readable medium storing instructions according to claim 15, wherein the first data set and the first checking data set are one of inertia, sound, electromagnetic field, and electric property of a transceiver.

17. The non-transitory, computer-readable medium storing instructions according to claim 15, wherein the at least one sensor is measuring an activity profile of radio frequency transmission from a transceiver.

18. The non-transitory, computer-readable medium storing instructions according to claim 15, wherein the second data set and the second checking data set are obtained by measuring a parameter of a motion controller of the unmanned vehicle.

19. The non-transitory, computer-readable medium storing instructions according to claim 15, wherein the second data set and the second checking data set are obtained by measuring the response of the un-manned vehicle to an action of the motion controller of the unmanned vehicle.

20. The non-transitory, computer-readable medium storing instructions according to claim 15, wherein the second data set and the second checking data set are obtained from a subsystem of the unmanned vehicle, wherein the subsystem is one of a camera module, a communications subsystem, and a remote identification module.
